(19) United States
(12) Patent Application Publication
(10) Pub. No.: US 2008/0080461 A1
(43) Pub. Date: Apr. 3, 2008

(54) RACH transmitter and receiver and method thereof

(76) Inventor: Jung Ah Lee, Pittstown, NJ (US)

Correspondence Address: Lucent Technologies, Inc.;Docket Administrator, Room 3J-219, 101 Crawfords Corner Road, Holmdel, NJ, 07733-3030, US

(21) Appl. No.: 11/540,853

(22) Filed: Sep. 29, 2006

(51) Int. Cl. H04B 7/216

(52) U.S. Cl. 370/342

(57) ABSTRACT

Disclosed is a method of, and apparatus for, processing a Random Access Channel (RACH) burst comprising a processed preamble group having at least two processed preambles. The processed preambles may be derived from short preambles, i.e., preamble comprising less than 887 bits, such that the RACH burst may be detected over shorter coherent accumulation time intervals relative to prior art coherent accumulation time intervals, thereby improving RACH burst detection. A transmitter generates a RACH burst comprising two or more processed preambles and transmits the RACH burst to a receiver. The receiver processes the RACH burst by correlating the two or more processed preambles to a plurality of reference signals in a frequency domain to produce a set of two or more frequency domain correlated outputs for each of the plurality of reference signals. The RACH burst is then detected based on energy associated with at least one frequency domain correlated output in the set of two or more frequency domain correlated outputs to a threshold energy value.

### FIELD OF THE INVENTION

The present invention relates generally to wireless communication systems and, in particular, to random access channels.

### BACKGROUND OF THE INVENTION

To increase system capacity, Universal Mobile Telecommunication System (UMTS) based wireless communication systems will change from a Code Division Multiple Access (CDMA) air interface to an Orthogonal Frequency Division Multiple Access (OFDMA) air interface. The OFDMA air interface will comprise a plurality of orthogonal sub-carrier frequencies. A subset of the plurality of orthogonal sub-carrier frequencies will support a non-synchronized Random Access Channel (RACH) for User Equipments (UE) to use when initially accessing the wireless communication system and performing uplink synchronization, among other things.

Several possible structures for the non-synchronized RACH have been proposed. In one proposal, the non-synchronized RACH comprises an access slot occupying, in terms of time and frequency space, a transmission time interval (TTI) of 1.0 ms and a 1.25 MHz bandwidth, respectively. The access slot comprises a first gap period, a preamble period and a second gap period. The first gap period corresponds to a time interval T_{DS1} associated with a maximum delay spread or multi-path delay. The preamble period corresponds to a preamble transmission time interval T_{P1}. The second gap period corresponds to the time interval T_{DS1} plus a time interval T_{GP1} associated with a maximum round trip propagation delay between a Node B and a UE (which is within a cell associated with the Node B).

Bursts are transmitted over the non-synchronized RACH (referred to herein as “RACH bursts”) by UEs attempting, for example, to initially access the system. Each RACH burst comprises a first gap sequence, a processed preamble and a second gap sequence. The first gap sequence comprises N_{DS1} zero samples, wherein N_{DS1}≧1. The first gap sequence is transmitted over the first gap period. The second gap sequence comprises N_{DS1} plus N_{GP1} zero samples, wherein N_{GP1}≧1. The second gap sequence is transmitted over the second gap period.

The processed preamble is derived from a preamble comprising approximately 887 bits. Specifically, the processed preamble is obtained by processing the preamble in accordance with at least a discrete Fourier Transform (DFT) operation and an Inverse Fast Fourier Transformer (IFFT) operation. The processed preamble comprises N_{P1} samples and is transmitted over the preamble period.

The RACH burst is detected at the Node B using periodic correlation during which the RACH burst is coherently integrated over a coherent accumulation time interval equal to the length of the preamble. Increasing the coherent accumulation time interval enhances processing gain, thereby improving RACH burst detection. Thus, it is desirable to use preambles with long lengths, e.g., 877 bits, to derive the RACH bursts because it increases the coherent accumulation time interval.

However, under fading conditions, phase offsets are introduced into the RACH burst detection process. Such phase offsets can cause degradation in RACH burst detection. The amount of phase offset introduced will depend, in part, on the length of the coherent accumulation time interval. As the coherent accumulation time interval increases, so does the phase offset. And as the phase offset increases, so does degradation of detection performance.

### SUMMARY OF THE INVENTION

An embodiment of the present invention is a method of, and apparatus for, processing a Random Access Channel (RACH) burst comprising a processed preamble group having at least two processed preambles. The processed preambles may be derived from short preambles, i.e., preamble comprising less than 887 bits, such that the RACH burst may be detected over shorter coherent accumulation time intervals relative to prior art coherent accumulation time intervals, thereby improving RACH burst detection under fading conditions. In one embodiment, a transmitter generates a RACH burst comprising two or more processed preambles and transmits the RACH burst to a receiver. The receiver processes the RACH burst by correlating the two or more processed preambles to a plurality of reference signals in a frequency domain to produce a set of two or more frequency domain correlated outputs for each of the plurality of reference signals. The RACH burst is then detected based on energy associated with at least one of the frequency domain correlated outputs to a threshold energy value.

### BRIEF DESCRIPTION OF THE DRAWINGS

The features, aspects, and advantages of the present invention will become better understood with regard to the following description, appended claims, and accompanying drawings where:

FIG. 1 depicts a wireless communication system used in accordance with the present invention;

FIG. 2 depicts a non-synchronized RACH used in accordance with an embodiment of the present invention;

FIG. 3 depicts a transmitter used in accordance with one embodiment of the present invention; and

FIG. 4 depicts a receiver used in accordance with one embodiment of the present invention.

### DETAILED DESCRIPTION

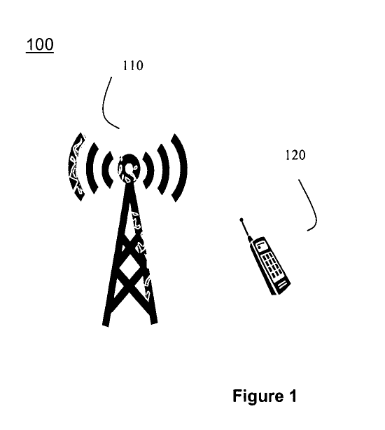

For purposes of illustration, the present invention will be described herein with reference to FIG. 1, which depicts a wireless communication system 100 used in accordance with the present invention. Wireless communication system 100 comprises a Node B 110 and a User Equipment (UE) 120. An Orthogonal Frequency Division Multiple Access (OFDMA) air interface is used for communications between Node B 110 and UE 120, for example, as described in the well-known Universal Mobile Telecommunication System (UMTS) standard specification.

The OFDMA air interface comprises N_{SYS} orthogonal sub-carrier frequencies, N_{SYS}>1. A subset of N_{RACH} orthogonal sub-carrier frequencies is used to support a non-synchronized Random Access Channel (RACH), where N_{SYS}>N_{RACH}. A burst is transmitted by UE 120 to Node B 110 over the non-synchronized RACH when UE 120 attempts, for example, to initially access wireless communication system 100. Such burst is referred to herein as a “RACH burst.”

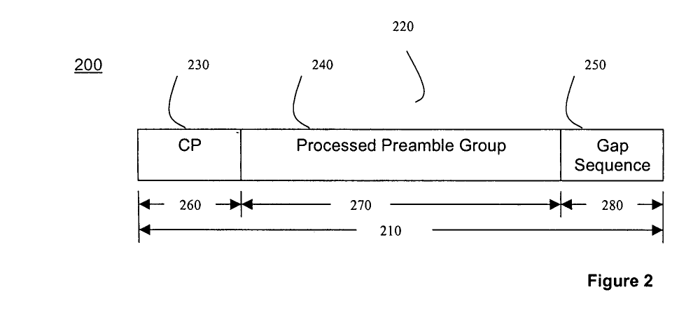

FIG. 2 depicts a non-synchronized RACH 200 used in accordance with another embodiment of the present invention. The non-synchronized RACH 200 comprises an access slot 210 for transmitting a RACH burst 220. Access slot 210, in terms of time and frequency space, occupies a time interval T_{AS} and a bandwidth f_{BW}, which includes N_{SYS} orthogonal sub-carriers. In one embodiment, time interval T_{AS} is 1.0 ms and the bandwidth f_{BW} is an integer multiple of 1.25 MHz.

Access slot 210 comprises a cyclic prefix (CP) period 260, a preamble period 270 and a gap period 280. Preamble period 270 corresponds to at least a time interval T_{P}. CP period 260 and gap period 280 both correspond to at least a time interval T_{DS} plus a time interval T_{GP}, i.e., CP period=gap period=T_{DS}+T_{GP}, wherein time interval T_{DS} corresponds to a maximum delay spread and time interval T_{GP} corresponds to a maximum round trip propagation delay between Node B 110 and UE 120 (which is within a cell associated with Node B 110). In one embodiment, time interval T_{DS} is based on a typical urban environment, such as the maximum delay spread used for GSM TU power-delay profile.

RACH burst 220 comprises N_{AS} samples, which include a CP 230, a processed preamble group 240 and a gap sequence 250. CP 230 comprises N_{DS} plus N_{GP} samples from processed preamble group 240, wherein N_{DS}, N_{GP}≧1. In one embodiment, the N_{DS} plus N_{GP} samples are taken from the end of processed preamble group 240. Gap sequence 250 comprises N_{DS} plus N_{GP} zero samples. CP 230 and gap sequence 250 are transmitted over CP period 260 and gap period 280, respectively.

Note that in another embodiment, CP 230 comprises N_{DS} plus N_{GP} zero samples. In yet another embodiment, CP 230 comprises N_{DS} zero samples or N_{DS} samples from processed preamble group 240, and CP period 260 corresponds to at least time interval T_{DS}.

Processed preamble group 240 comprises z processed preambles, where z is a repetition factor and is greater than or equal to 2. Each processed preamble comprises N_{P} samples and is derived from a short preamble (or other sequence with good auto and cross correlation properties) of length L, where N_{P} ≧1. For purposes of this application, the term “short preamble” should be construed to include preambles comprising less than 887 bits, i.e., L<887. In one embodiment, the number of bits comprising the short preamble is a prime number less than 887, such as 449 and 223. The short preamble can be a CAZAC sequence, such as a Generalized Chirp Like (GCL) sequence or a Zadoff-Chu with zero cross correlation zone (ZCZ) sequence.

Each processed preamble is derived by processing the short preamble in accordance with at least a DFT operation and an IFFT operation. In one embodiment, processed preamble group 240 comprises at least two processed preambles derived from a same short preamble. The two processed preambles may be exactly identical or inverse versions of each other.

Parameters N_{DS}, N_{P} and N_{GP} are dependent upon a variety of factors including, for example, bandwidth, sampling rate and access slot, among others. Table 1 depicts transmission parameters for the non-synchronized RACH for various bandwidths and sampling rates in accordance with one embodiment of the present invention. In this embodiment, non-synchronized RACH 210 comprises an access slot of 1.0 ms duration, RACH burst 220 is derived from a short preamble comprising 449 bits, and processed preamble group 240 includes two processed preambles, i.e., z=2. A maximum cell radius of 13.4 km and a typical urban environment in accordance with a GSM TU profile are assumed for calculating T_{GP} and T_{DS}, respectively.

TABLE 1

| | Sampling | | | | | | | | |
|---|---|---|---|---|---|---|---|---|---|
| Bandwidth | Rate | T_{P} | T_{DS} | T_{GP} | | | | | |
| (MHz) | (MHz) | (μs) | (μs) | (μs) | N_{AS} | L | N_{P} | N_{DS} | N_{GP} |
| 1.25 | 1.92 | 800 | 5.2 | 94.8 | 1920 | 449 | 768 | 10 | 182 |
| 2.5 | 3.84 | 800 | 5.2 | 94.8 | 3840 | 449 | 1536 | 20 | 364 |
| 5 | 7.68 | 800 | 5.2 | 94.8 | 7680 | 449 | 3072 | 40 | 728 |
| 10 | 15.36 | 800 | 5.2 | 94.8 | 15360 | 449 | 6144 | 80 | 1456 |
| 20 | 30.72 | 800 | 5.2 | 94.8 | 30720 | 449 | 12288 | 160 | 2912 |

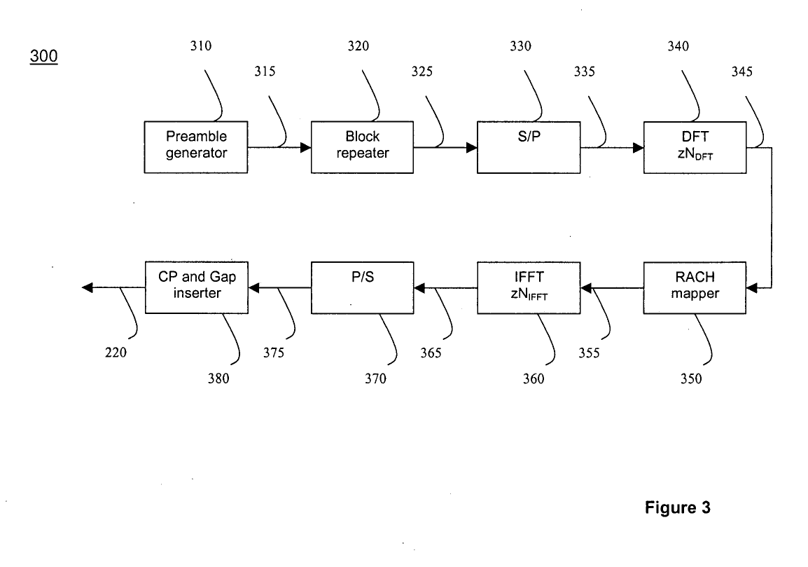

UE 120 includes a transmitter for transmitting RACH burst 220 of FIG. 2. FIG. 3 depicts a transmitter 300 used in accordance with one embodiment. Transmitter 300 comprises a preamble generator 310, a block repeater 320, a serial to parallel (S/P) converter 330, a Discrete Fourier Transform (DFT) precoder 340, a RACH mapper 350, an Inverse Fast Fourier Transformer (IFFT) 360, a parallel to serial (P/S) converter 370, and a CP and gap inserter 380. These elements may be implemented, for example, through dedicated or shared hardware including, but not limited to hardware capable of executing software.

Preamble generator 310 is a device for generating a short preamble 315. In one embodiment, the preamble generator 310 selects short preamble 315 from a set comprising S short preambles, wherein S>1 and each of the short preambles in the set has a bit length L. Short preamble 315 is provided as input to block repeater 320. Short preamble 315 is repeated z times by block repeater 320 to produce block repeater output 325 comprising z short preambles. In one embodiment, all z short preambles in block repeater output 325 are identical. In another embodiment, at least one of the short preambles in block repeater output 325 is identical to inputted short preamble 315 and at least one of the short preambles in block repeater output 325 is an inverse version of inputted short preamble 315.

S/P converter 330 converts block repeater output 325 from a serial stream to a S/P output 335 comprising z sets of N_{DFT} parallel streams, where N_{DFT}=N_{RACH}. DFT precoder 340 performs a discrete Fourier transform to convert S/P output 335 from the time domain into the frequency domain and produce a DFT precoder output 345 comprising z sets of N_{DFT} parallel streams of frequency domain signals. RACH mapper 350 maps each set of N_{DFT} parallel streams to the subset of N_{RACH} orthogonal sub-carrier frequencies which support the non-synchronized RACH. RACH mapper 350 produces a RACH mapper output 355 comprising z sets of N_{IFFT} parallel streams of mapped frequency domain signals, where N_{IFFT}=N_{SYS}. The z sets of N_{IFFT} parallel streams include z sets of N_{DFT} occupied orthogonal sub-carriers and z sets of N_{IFFT}-N_{DFT} unoccupied orthogonal sub-carriers which have been mapped to zero samples.

IFFT 360 performs an inverse fast Fourier transform to convert RACH mapper output 355 from the frequency domain to the time domain. IFFT 360 produces an IFFT output 365 comprising z sets of N_{IFFT} parallel streams of samples. P/S converter 370 converts IFFT output 365 into a P/S output 375 comprising a serial stream of z sets of N_{P} samples or processed preambles, i.e., processed preamble group 240, where N_{P}=N_{SYS}. CP and gap inserter 380 appends CP 230 and gap sequence 250 to P/S output 375 to produce RACH burst 220, which is subsequently transmitted by a radio transmitter interface at transmitter 300, not shown. In one embodiment, CP 230 is added to the beginning of P/S output 375, and gap sequence 250 is added to the end of P/S output 375.

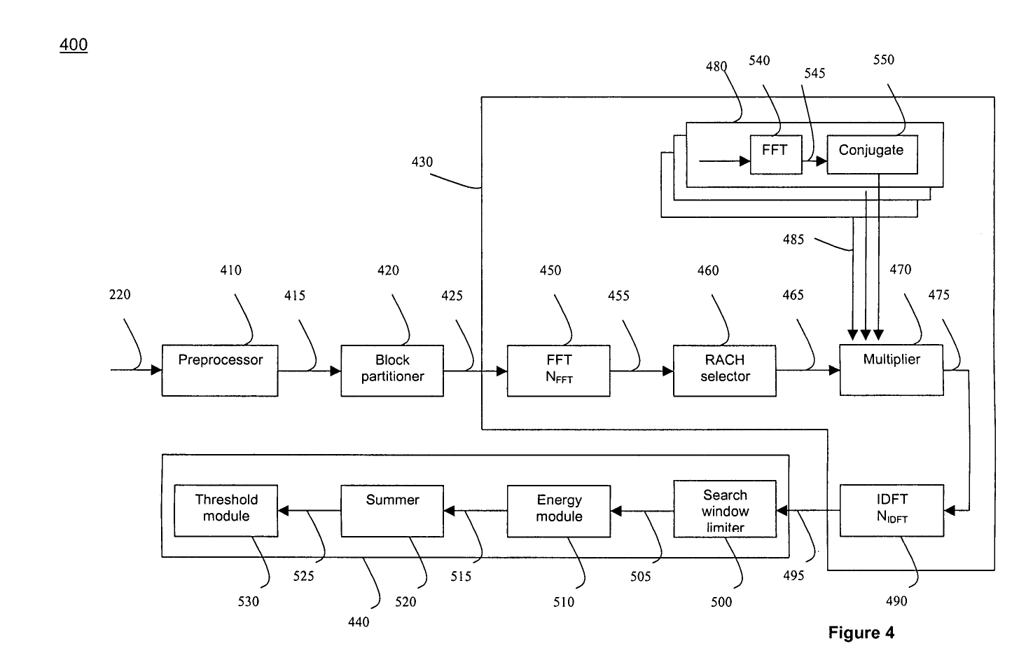

The transmitted RACH burst 220 of FIG. 2 is received by a receiver at Node B 110. FIG. 4 depicts a receiver 400 used in accordance with one embodiment. Receiver 400 comprises a preprocessor 410, a block partitioner 420, a frequency domain correlator 430 and an energy detector 440. These elements may be implemented, for example, through dedicated or shared hardware including, but not limited to hardware capable of executing software.

RACH burst 220 is received by a radio receiver interface, not shown, at receiver 400. Preprocessor 410 removes CP 230 from received RACH burst 220 to produce preprocessor output 415. Specifically, preprocessor 410 removes from the received RACH burst 220 a fixed number of samples corresponding to the CP samples.

Block partitioner 420 partitions preprocessor output 415 into a set of z blocks 425, wherein each block 425 comprises N_{P} samples of preprocessor output 415. The set of z blocks 425 is provided as input to frequency domain correlator 430, which is a block-wise processor for correlating the set of z blocks 425 to a plurality of reference signals in the frequency domain, thereby producing frequency correlated outputs.

Frequency domain correlator 430 comprises a Fast Fourier Transformer (FFT) 450, a RACH selector 460, a multiplier 470, a plurality of reference signal generators 480, and an Inverse Discrete Fourier Transformer (IDFT) 490. FFT 450 converts each block 425 from the time domain into the frequency domain to produce a set of z FFT outputs 455, wherein each FFT output 455 comprises N_{FFT} parallel streams of frequency domain signals and N_{FFT}=N_{SYS}. RACH selector 460 selects, from each FFT output 455, the N_{RACH} streams corresponding to the orthogonal sub-carrier frequencies which support the non-synchronized RACH. RACH selector 460 outputs a set of z RACH selector outputs 465, wherein each RACH selector output 485 comprises a set of N_{RACH} streams.

Multiplier 470 multiplies each RACH selector output 465 with a reference signal 485 provided by one of the plurality of reference signal generators 480 to produce a set of z multiplier outputs 475 for each reference signal 485, wherein each multiplier output 475 comprises parallel streams of multiplied signals, i.e., frequency domain signals multiplied with a reference signal. Note that the same reference signal 485 will be used to process, i.e., multiply, the entire set of z RACH selector outputs 465. After the entire set of z RACH selector outputs 465 have been processed with that reference signal 485, then another reference signal 485 will be used to multiple the same set of z RACH selector outputs 465. Such iterative processing may continue until the set of z RACH selector outputs have processed with each reference signal 485.

In one embodiment, the number of reference signal generators 480 is equal to S, i.e., number of short preambles in the set of short preambles. Each of the plurality of reference signal generators 480 comprises a FFT 540 and a conjugate module 550. A different short preamble (from the set of S short preambles) is used by each of the reference signal generators 480 to generate a different reference signal 485. In each reference signal generator 480, a short preamble is transformed by FFT 540 from the time domain into the frequency domain to produce a FFT output 545, i.e., frequency domain representation of the short preamble. Conjugate module 550 converts FFT output 545 into reference signal 485, which is a complex conjugate representation of FFT output 545. Alternately, reference signals 485 may be pre-computed and stored in some buffer to reduce the amount of real-time computation.

For each set of z multiplier outputs 475 associated with a same reference signal 485, IDFT 490 converts each multiplier output 475 in that set from the frequency domain to the code domain to produce a set of z IDFT outputs 495, wherein each IDFT output 495 comprises correlation values corresponding to the delay spread. Such set of z IDFT outputs 495 corresponds to a set of frequency domain correlated outputs for a particular reference signal 485.

The set of z IDFT outputs 495 (associated with a same reference signal 485) is provided as input to energy detector 440 for determining whether a RACH burst has been received. Energy detector 440 comprises a search window limiter 500, an energy module 510, a summer 520 and a threshold module 530. Search window limiter 500 limits each IDFT output 495, in terms of time, to a search window size corresponding to time interval T_{GP} plus time interval T_{DS} to produce a set of z limited outputs 505. Alternately, the search window size corresponds to time interval T_{GP} or time interval T_{DS}.

Energy module 510 determines an amount of energy associated with each limited output 505, for example, by squaring a magnitude or gain value associated with that particular limited output 505. A set of z energy outputs 515 is produced by energy module 510 for the set of z limited outputs 505. In summer 520, two or more energy outputs 515 in the same set of z energy outputs 515 (associated with a same reference signal 485) are summed together to produced a summer output 525. Threshold module 530 determines whether a RACH burst is present by comparing summer output 525 to a threshold energy value. If summer output 525 is greater than the threshold energy value, then a RACH burst is deemed detected. If summer output 525 is not greater than the threshold energy value, then energy detector 440 checks the next set of z IDFT outputs 495 (i.e., IDFT outputs 495 associated with another reference signal 485) to determine whether a RACH burst has been received.

Note that, in an alternate embodiment, energy detector 440 does not include summer 520. In such an embodiment, individual energy outputs 515 are compared to the threshold energy value to determine whether a RACH burst has been received.

Although the present invention has been described in considerable detail with reference to certain embodiments, other versions are possible. Therefore, the spirit and scope of the present invention should not be limited to the description of the embodiments contained herein.

1. A method of processing a Random Access Channel (RACH) burst in a wireless communication system comprising the steps of:
generating a RACH burst comprising two or more processed preambles; and
transmitting the RACH burst over an access slot associated with a RACH.

2. The method of claim 2, wherein the RACH burst further comprises a cyclic prefix and a gap sequence, the cyclic prefix comprising samples from at least one of the two or more processed preambles, and the gap sequence comprising zero samples.

3. The method of claim 1, wherein the two or more processed preambles are derived from a same preamble.

4. The method of claim 3, wherein the preamble is a short preamble comprising less than 887 bits.

5. A method of processing a Random Access Channel (RACH) burst comprising two or more processed preambles in a wireless communication system comprising the steps of:
correlating the two or more processed preambles to a plurality of reference signals in a frequency domain to produce a set of two or more frequency domain correlated outputs for each of the plurality of reference signals; and
detecting the RACH burst by comparing, to a threshold energy value, energy associated with at least one of the frequency domain correlated outputs.

6. The method of claim 5 comprising the addition step of:
removing a cyclic prefix from the RACH burst prior to the step of correlating.

7. The method of claim 5, wherein the step of correlating comprises the steps of:
performing a fast Fourier transform (FFT) on a processed preamble to produce a FFT output comprising parallel streams of frequency domain signals;
selecting one or more parallel streams of frequency domain signals, from the FFT output, corresponding to a RACH to produce a RACH selector output;
multiplying the RACH selector output with a reference signal to produce a multiplier output comprising parallel streams of multiplied signals; and
performing an inverse discrete Fourier transform (IDFT) on the multiplier output to produce a frequency domain correlated output for the reference signal.

8. The method of claim 5, wherein the step of detecting comprises the steps of:
limiting a frequency domain correlated output to a search window size to produce a limited output;
determining an energy value for the limited output; and
comparing the energy value to a threshold energy value.

9. The method of claim 5, wherein the step of detecting comprises the steps of:
limiting at least two frequency domain correlated outputs to a search window size to produce at lest two limited outputs;
determining energy values for each of the at least two limited outputs;
summing the energy values to produce a summed output; and
comparing the summed output to a threshold energy value.

10. A transmitter comprising the steps of:
a discrete Fourier transformer (DFT) for transforming a preamble group into a DFT output, wherein the preamble group includes at least two preambles;
a Random Access Channel (RACH) mapper for mapping the DFT output to orthogonal sub-carrier frequencies which support a RACH to produce a RACH mapper output;
an inverse fast Fourier transformer (IFFT) for transforming the RACH mapper output into an IFFT output;
a parallel to serial (P/S) converter for converting the IFFT output from a parallel stream to a serial stream and producing a P/S output; and
a cyclic prefix and gap inserter for adding a cyclic prefix and a gap sequence to P/S output to produce a RACH burst.

11. The transmitter of claim 10, wherein the preamble group includes a first preamble and a second preamble, and the second preamble is an inverse version of the first preamble.

12. The transmitter of claim 10, wherein the cyclic prefix comprises one or more samples from the P/S output.

13. The transmitter of claim 10, wherein the cyclic prefix and gap sequence comprise zero samples.

14. A receiver method of processing a Random Access Channel (RACH) burst comprising two or more processed preambles in a wireless communication system comprising:
a frequency domain correlator for correlating the two or more processed preambles to a plurality of reference signals in a frequency domain and producing a set of two or more frequency domain correlated outputs for each of the plurality of reference signals; and
an energy detector for detecting the RACH burst by comparing, to a threshold energy value, energy associated with at least one of the frequency domain correlated outputs.

15. The receiver of claim 14 further comprising:
a preprocessor for removing a cyclic prefix from the RACH burst prior to correlating the two or more processed preambles in the frequency domain correlator.

16. The receiver of claim 14, wherein the frequency domain correlator comprises:
a fast Fourier transformer (FFT) for transforming a processed preamble from a time domain to a frequency domain and producing a FFT output comprising parallel streams of frequency domain signals;
a RACH selector for selecting one or more parallel streams of frequency domain signals, from the FFT output, corresponding to a RACH and producing a RACH selector output;
a multiplier for multiplying the RACH selector output with a reference signal to produce a multiplier output comprising parallel streams of multiplied signals; and
an inverse discrete Fourier transformer (IDFT) for transforming the multiplier output from the frequency domain to a code domain and producing a frequency domain correlated output for the reference signal.

17. The receiver of claim 14, wherein the energy detector comprises:
a search window limiter for limiting a frequency domain correlated output to a search window size to produce a limited output;
an energy module for determining an energy value for the limited output; and
a threshold module for comparing the energy value to a threshold energy value.

18. The receiver of claim 14, wherein the energy detector comprises:
a search window limiter for limiting at least two frequency domain correlated outputs to a search window size to produce at least two limited outputs;
an energy module for determining energy values for each of the at least two limited outputs;
a summer for summing the energy values to produce a summed output; and
a threshold module for comparing the summed output to a threshold energy value.
